(19) United States
(12) Patent Application Publication
(10) Pub. No.: US 2014/0311608 A1
(43) Pub. Date: Oct. 23, 2014

(54) Tone Carrier Locatable Conduit

(71) Applicants: Robert M. Adams, Metairie, LA (US); Andrew J. Cousin, Kenner, LA (US)

(72) Inventors: Robert M. Adams, Metairie, LA (US); Andrew J. Cousin, Kenner, LA (US)

(21) Appl. No.: 14/258,979

(22) Filed: Apr. 22, 2014

Related U.S. Application Data
(60) Provisional application No. 61/814,650, filed on Apr. 22, 2013.

(51) Int. Cl. F16L 55/00; G01V 3/08

(52) U.S. Cl. CPC F16L 55/00; G01V 3/081
USPC 138/104

(57) ABSTRACT

Tone carrier locatable conduit having inner pipes covered by an outer jacket and a plurality of passive antennas arranged at regular intervals along a length of the conduit allowing the conduit to be locatable along an entire length of the conduit.

### FIELD

The present disclosure relates generally to locatable conduits, and in exemplary though non-limiting embodiments, to a novel conduit bundle having passive antennas incorporated at regular intervals within said conduit bundle.

### BACKGROUND

The ability to locate underground utilities after their installation has been a mainstay in the construction industry. Utilities need to be locatable in order to avoid potential damage when they become exposed by excavation, construction, maintenance, etc.

Tone generators and receivers are sometimes used to locate buried utilities. In one previously known embodiment, tone generators are electrically connected to one end of a pipe system, and send a tone signal along the path of the system so that the tone can be honed in on and located by a receiver as it is passed above the ground.

An obvious limitation of this system is that the pipe system must contain a continuous metallic component in order to carry the electrical signal along the length of the pipe run. Nonmetallic pipe systems can be located using this method by either adding an electrically conductive wire or tape within the system, or perhaps adjacent to the system in the same trench.

Another limitation to the use of tone generators is that the further the signal travels, the more the strength will fade, eventually resulting in a complete loss of the signal. The continuity of wires added to a system can be also compromised by inadvertent severing, chemical deterioration, etc., which will render the locating wire useless beyond the point of the break.

The use of metal detectors is another currently known method of locating underground pipe systems. This method is also dependent on the presence of sufficient metal in order for the detector to sense the system beneath the ground.

Locating nonmetallic pipe systems can also be accomplished by installing passive antennas along the path of the installation. Such antennas have the ability to reflect a signal transmitted from a location device above the ground, though their use is inherently limited to installation on the outside of pipes, loosely buried along with the pipe in a trench, within a tape that is installed continuously just above a pipe inside a trench, etc.

Antennas attached to the outside of the pipes are subject to dislodgment and/or damage during pipe installation, and therefore require a heavy protective encasement around each antenna. Antennas loosely buried outside of the pipe in the trench are frequently exposed to inadvertent exposure and damage, and failure to be returned properly within a trench during maintenance or the like in order to facilitate future use.

There is, therefore, a long-felt but unmet need for simple, efficient and reliable means for detecting and locating buried conduit that overcomes the deficiencies of the prior art.

### SUMMARY

In an exemplary embodiment of the present invention, a conduit bundle is provided, including: an outer jacket; at least one inner pipe inside the outer jacket; and a plurality of passive antennas arranged at regular intervals along a length of the conduit bundle beneath the outer jacket. The passive antennas may be configured to make the conduit bundle locatable. The passive antennas may be installed between the plurality of inner pipes and the outer jacket. The outer jacket may provide protection to the plurality of passive antennas.

### BRIEF DESCRIPTION OF DRAWINGS

FIG. 1 is a cross-section view of a conduit bundle according to an exemplary embodiment of the present invention.

### DETAILED DESCRIPTION

According to one example embodiment of the invention, a passive locating antenna is installed beneath the outer jacket of a pipe bundle, preferably between the outer jacket and the inner pipes, during the manufacture of an associated locatable nonmetallic pipe system.

In a further embodiment, the antennas are disposed at predetermined intervals along the entire length of the pipe in order to make the pipe locatable after installation in the ground. In other embodiments, the passive antennas are protected from damage because of their location under the outer jacket.

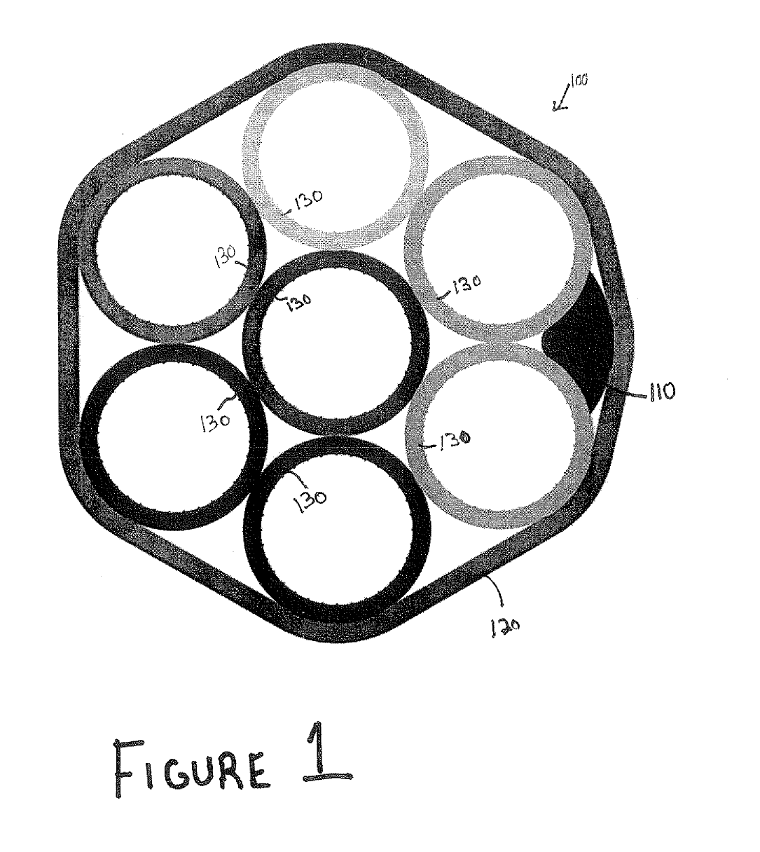

In the embodiment shown in FIG. 1, conduit bundle 100 has a passive antenna 110 installed beneath outer jacket 120 and between outer jacket 120 and a plurality of inner pipes 130. Multiple passive antennas 110 may be installed at regular intervals along a length of conduit bundle 100. Passive antenna 110 is configured to make conduit bundle 100 locatable after it is installed.

Factory installation within the pipe system eliminates the waste of valuable field time, and eliminates the possibility of displacement when installed loosely within a trench as is common in the prior art. Factory installation of the antennas in a protected location under the outer jacket of the pipe also eliminates the need for the antennas to be manufactured with thicker, more expensive protective housings.

Passive antennas systems used for locating purposes also avoid the need for field installation of tone generator wires that can be rendered useless if inadvertently severed or eroded by corrosion. Employment of such antennas ultimately allows the pipe installation to be locatable throughout the entire length of the run, no matter the distance.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

What is claimed is:

1. A conduit bundle, comprising:
an outer jacket;
at least one inner pipe inside the outer jacket;
a plurality of passive antennas arranged at regular intervals along a length of the conduit bundle beneath the outer jacket.

2. The conduit bundle of claim 1, wherein the passive antennas are configured to make the conduit bundle locatable.

3. The conduit bundle of claim 1, wherein the passive antennas are installed between the at least one inner pipe and the outer jacket.

4. The conduit bundle of claim 1, wherein the outer jacket provides protection to the plurality of passive antennas.
